(19) United States
(12) Patent Application Publication
(10) Pub. No.: US 2007/0011712 A1
(43) Pub. Date: Jan. 11, 2007

(54) System for multimedia on demand over internet based network

(75) Inventors: David White, Boca Raton, FL (US); Abhishek Kumbhat, Jodhpur (IN)

Correspondence Address: GREENBERG-TRAURIG, 1750 TYSONS BOULEVARD, 12TH FLOOR, MCLEAN, VA, 22102, US

(73) Assignee: White Technologies Group, Boca Raton, FL (US)

(21) Appl. No.: 11/480,576

(22) Filed: Jul. 5, 2006

Related U.S. Application Data
(60) Provisional application No. 60/696,491, filed on Jul. 5, 2005.

(51) Int. Cl. H04N 7/173

(52) U.S. Cl. 725/112; 725/109; 725/113

(57) ABSTRACT

A multimedia on demand system includes a multimedia server configured to connect to an internet-based network and to transmit audio/video programs on demand via said internet-based network. A plurality of customer premises units connected to the internet-based network via a network interface are configured to receive the audio/video programs via the internet-based network. A remote control unit in communication with each customer premises unit provides user input to the unit. An audio video system is connected to each customer premises unit for reproduction of the audio/video programs. The system can be used to provide multimedia on demand services over the internet, including but not limited to movies, TV shows, audio and video programs, product catalogs, tourist guides, and video games. In one embodiment the system includes an “instant watch” mode and “wait and watch” mode, thereby allowing users to enjoy multimedia services instantly as the audio video program is being downloaded or after the download is substantially complete.

This is a non-provisional application which claims the benefit of U.S. Provisional Patent Application No. 60/696,491 filed Jul. 5, 2005, the entire disclosure of which is incorporated herein by reference.

### BACKGROUND OF THE INVENTION

1. Field of the Invention

The present invention relates to the field of multimedia delivery on customer demand over an internet based network, and in particular to a system and method for providing multiple audio video services with true on-demand delivery to customer premises.

2. Description of Related Art

Broadcasts of programming via direct satellite, cable television (CATV) networks, and other conventional video delivery networks typically deliver predetermined audio video programs at predetermined times. However, the consumer has always desired the freedom of watching the programs of his or her own choosing at the times of his or her own choosing.

As an alternative, consumers will often elect to use a video rental store or delivery service to obtain and view programs of their choice at a convenient time. The former requires the consumer to go to a video rental store to rent a DVD or VHS cassette. The latter requires the delivery service to mail the DVD to the customer, and this process usually takes 2-4 days to get the desired video in hand. During this time, the viewer might loose interest in the particular video. After receiving and viewing the video, the consumer must mail back the DVD to the video retailer or others, which presents an inconvenience to the user.

Other methods of delivering video programming on demand to a consumer include Pay-Per-View (PPV). In a PPV system, the cable operator or satellite service company provides a stream of various scrambled programs at predetermined times. If the customer desires to watch a particular program, the cable operator or satellite service company send an authorization key to customer's set top box to descramble the broadcasted program on customer's request. In this manner the user can watch the program of his/her choice by paying for the particular program. However in PPV systems, a user's choice is limited to the titles and programs made available for Pay-Per-View by the cable operator or satellite service company, which typically includes only a relatively small number of selections.

Customer demand for full video on demand service to customer premises, such as to the delivery of any demanded video to customer premises at any time, with full recording functionalities, has been increasing. In the past few years, various video on demand services have been proposed to address this need, but each has very limited features. Such services not only require a huge infrastructure, but also require very high bandwidth connectivity to end user premises.

### SUMMARY OF THE INVENTION

The present invention provides a new system and method of providing full video on demand, wherein the user is able to receive virtually any video program at virtually any moment of time using relatively simple system architecture.

In one embodiment, the invention provides a multimedia on demand system that includes a multimedia server configured to connect to an internet-based network and to transmit audio/video programs on demand via said internet-based network. A plurality of customer premises units connected to the internet-based network via a network interface are configured to receive the audio/video programs via the internet-based network. A remote control unit in communication with each customer premises unit provides user input to the unit. An audio video system is connected to each customer premises unit for reproduction of the audio/video programs. The system can be used to provide multimedia on demand services over the internet, including but not limited to movies, TV shows, audio and video programs, product catalogs, tourist guides, and video games. In one embodiment the system includes an “instant watch” mode and “wait and watch” mode, thereby allowing users to enjoy multimedia services instantly as the audio video program is being downloaded or after the download is substantially complete.

### BRIEF DESCRIPTION OF THE DRAWINGS

FIG. 1 is a block diagram showing a network architecture and placement of equipment at home customer premises in accordance with one embodiment of the present invention;

FIG. 2 is a flow diagram illustrating a flow of video programs in accordance with one embodiment of the present invention;

FIG. 3 is a functional block diagram illustrating the customer premises equipment according to one embodiment of the present invention.

### DETAILED DESCRIPTION OF THE INVENTION

The invention in one embodiment provides a system capable of providing virtually any video program to customer premises at the customer's desired time without being dependent on very high bandwidth at or before the customer end. The invention provides a new compact integrated system for video on demand services with full VCR functionality to end customers. The system can be transparent to current network architecture and can be used in combination with very common internet based networks. In this respect, the invention in one embodiment does not require a very high bandwidth of internet connectivity at or before the customer end. The system can also provide audio (e.g., MP3) song transmission upon customer demand, the audio being directly played on their audio systems. The system of present invention in one embodiment provides the following multimedia on demand (MoD) services over internet: Video programs (Movies, TV shows, music videos, recorded events) on demand; MP3 songs on demand; Product catalog; Tourist guide; and Video games on demand.

These services are preferably provided using a single Customer Premises Equipment (CPE) device with accompanying remote control at the customer premises. The CPE may be, e.g., a set-top box, a unit provided in proximity to the user's audio video system (Audio player, Television, Amplifier etc.), a unit provided at a network interface on the customer's premises, a unit provided at a central location which has connectivity to multiple audio video systems in the premises, or any combination thereof. The system is preferably standalone and feeds directly into any audio video system at customer premises. It can be compatible with a range of analog and digital audio video interfaces. The customer can request any of the services via the equipment using a remote control or a front panel keypad and visual user interface on their television screen. The present invention does not interfere with existing audio/video broadcast systems, and preferably provides the connectivity to integrate with such systems.

Video programs which are provided on-demand typically require a very high bandwidth (>1.5 Mbps for MPEG1 video) network connectivity up to end customer equipment. The multimedia on demand (MoD) system in accordance with the present invention in one embodiment further provides two modes of video delivery which are customizable according to network connectivity. The modes of video delivery are 1) Instant Watch mode 2) Wait & Watch mode. If the internet connectivity up to customer premises is sufficient to get a continuous video stream, then the customer can get video in instant watching mode and begin watching the movie at the time he has requested. However, if the internet connectivity is not sufficient to get a continuous video stream, the system may operate in Wait & Watch mode, wherein the video stream is first downloaded substantially completely before the user can start watching the movie. The time taken by the system to download the video program depends on bandwidth of internet connectivity at customer premises. The end user can also choose display size from among 3-4 sizes according to his requirement and his internet connectivity. A similar choice may be given for picture quality.

FIG. 1 shows the system architecture for the MoD system in accordance with the present invention in one embodiment. The system consists of six major sections: 1) a Multimedia server 101 with an extremely large audio/video archive placed at service provider's premises; 2) The internet-based network 102 consisting of various routers, bridges, gateways and cables running to customer premises 103; 3) Cable/DSL Modem 104 (as per customer's internet connection) at customer premises; 4) CPE 105 in accordance with the present invention; 5) Remote control (not shown in figure) for the CPE and 6) Audio 106/Video 107 system at customer premises. Multimedia server 101 of FIG. 1 has a database management system software running, which keeps all the audio/video archive well maintained. This helps customer to search for their desired program very easily. Quick and advanced search options utilizing various fields are also provided over audio/video archive database. Network manager running on the same server manages all the channels for transferring IP (internet protocol) packets to the customer premises. For customers demanding for common popular programs, video/audio programs are multicast on same channel. The data from multimedia server is transferred to customer premises via internet based network 102. The IP packets reach customer premises through various network elements like Gateways, Routers, Bridges, Switches and various cables. The internet based network 102 interfaces with the modem 103 at customer premises. The modem can be cable modem, DSL modem, or other appropriate network interface as per customer's internet connectivity. The modem 103 connects to personal computer or work station 108 for internet connectivity. The CPE 105 in accordance with present invention is connected to the network 102 via the modem 103 through Ethernet RJ 45 port. On the other side, CPE 105 is connected to audio system 106 through a stereo audio output. CPE 105 is also connected to various video systems 107 like television, projection television, digital television etc. through various types of connections. For all VCR type of functions, the CPE is provided with a front panel keypad for functions like pause, play, forward, fast forward, rewind, menu etc. The same functions are also provided over a remote control. Visual user interface for video programs is provided over television screen and user entry can be done either by the remote control or by front panel keypad of the CPE.

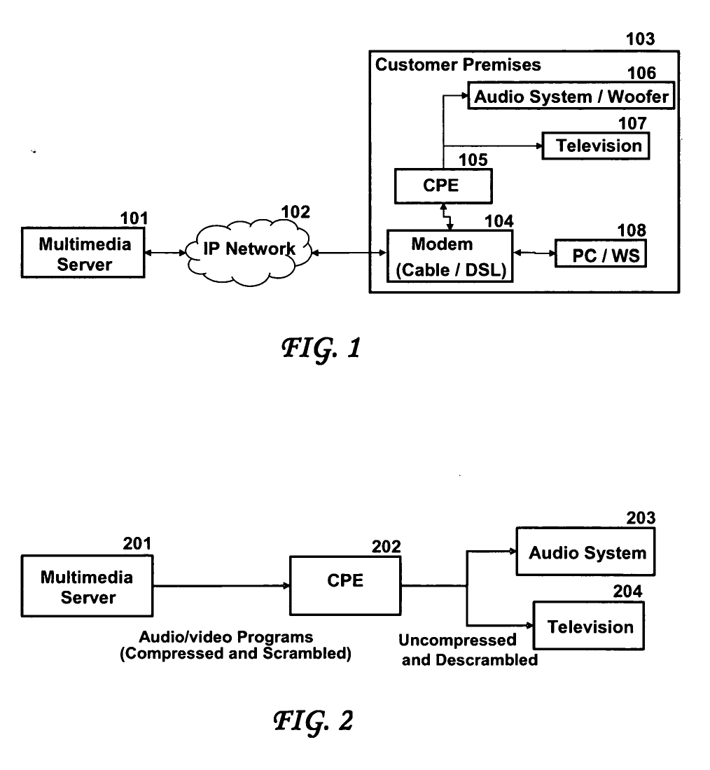

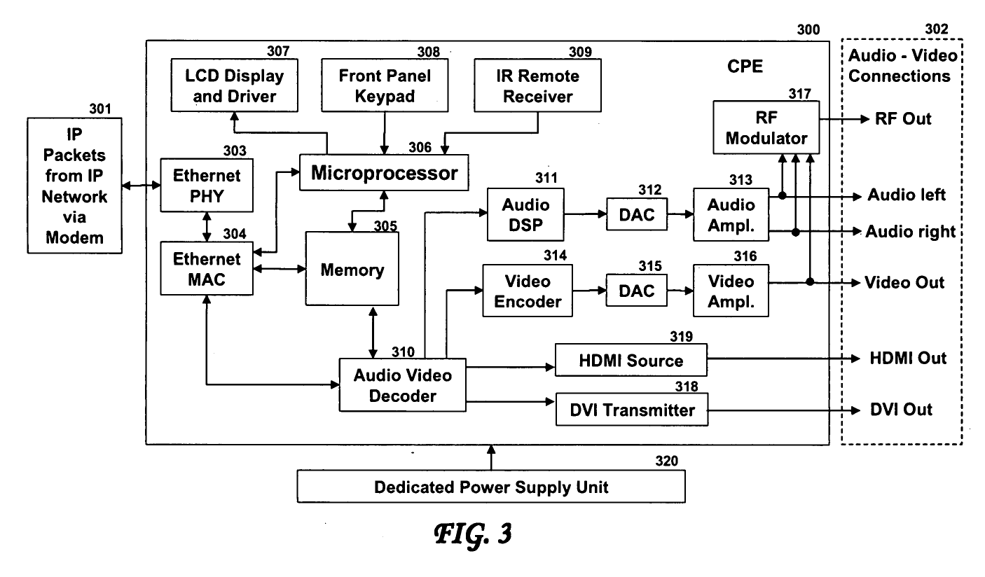

FIG. 2 shows the data flow diagram of MoD system. Audio video programs flowing from multimedia server 201 to CPE 202 is scrambled to ensure only authentic usage of delivered data. The data on network flows is also compressed to ensure maximum utilization of channel capacity over internet based network. The CPE 202 at customer premises ensures proper descrambling of scrambled data if the IP packet is authentic for the CPE. The CPE also ensures uncompressed audio delivery to audio system 203 and audio-video delivery to television 204. This data flow diagram, FIG. 2, ensures secure data delivery over internet based network.

FIG. 3 is a block diagram of CPE 300 showing functional blocks of the embodiment. With reference to FIG. 3, CPE 300 has interface with internet based network via modem 301 and various audio video interfaces 302 to a series of audio video systems.

In CPE 300, connection to internet 301 is made through Ethernet physical layer interface 303 via modem and then the IP packets are received by the Ethernet media access controller (MAC) 304. Media access controller is for proper channel allocation over the shared LAN. It also ensures error free packets from the network with proper interface with Ethernet physical layer. In accordance with present invention, the desired audio/video program is divided into various sections and each section flows over different IP packets with their serial number along with. All such packets received through Ethernet MAC 304 are stored in temporary location in memory 305 under control of microprocessor 306. Microprocessor 306 keeps an eye on all received packets and remaining ones. It also requests for the remaining packets at a regular interval of time. As soon as all packets are received, microprocessor 306 rearranges them into a single stream of audio and video programs and keeps it as an archive at CPE memory 305.

A small LCD 307 screen is also provided in the CPE 300 to display current updates like currently running program title, duration of the program, passed time, download mode (ON/OFF) etc. Microprocessor 306 controls the LCD display 307 through the LCD display driver.

CPE 300 is provided with front panel keypad 308 to take user input to select audio/video programs, play, fast forward, rewind etc. Microprocessor 306 takes input from the keypad and understands user's input and perform accordingly. Along with this, the user can also give his input by a remote control, not shown in the FIG., provided with the CPE 300. The CPE receives input from the remote control via IR (infrared) receiver 309 and microprocessor 306 and, after interpreting the command as per a predetermined protocol, performs the desired function.

Once downloaded and stored into memory 305, the user can play the particular audio/video program. As soon as CPE 300 receives user input commanding it to play, desired program from memory 305 is sent to audio/video decoder 310. Audio video decoder 310 decodes incoming audio video programs in MPEG2 format as per standards. Audio video decoder 310 is preferably backward compatible to MPEG1, MP3 and other standard formats. Audio signals decoded from MPEG/MP3 programs are provided to audio digital signal processing (DSP) section 311. Audio DSP section 311 can perform echo cancellation and various audio effects. Digital audio output from audio DSP section 311 is delivered to an audio digital-to-analog converter (DAC) 312. Audio DAC 312 converts the digital audio signal to an analog stereo audio signal. After amplification by audio amplifier 313, this analog stereo audio output can be fed to stereophonic audio input jacks of audio video systems.

For video programs, audio video decoder 310 decodes MPEG and other backward-compatible signals and generates RGB digital video output. The video may be in another digital video format according to the particular package used for the application. This RGB digital video output from audio video decoder 310 is fed to video encoder 314 which converts RGB output to single stream video out and that onwards is fed to DAC 315. DAC 315 generates composite analog video from its output. After amplification by video amplifier 316, the composite analog video signal can be fed to a composite video input of a video system.

If the audio/video input of the Audio Visual system (Television etc.) is busy with any other equipment like DVD player, then the video programs from CPE 300 can be fed to the television through RF input. CPE 300 converts analog stereo audio and composite video signal to RF signals using the RF modulator 317, inside the same embodiment. This RF input can be either directly fed to RF input of television or via a video switcher in parallel to CATV/satellite input.

Along with these analog/RF outputs, CPE 300 also facilitates digital audio video output for digital television (DTV)/High definition television (HDTV). The output of audio video decoder 310 is provided to a DVI (digital video interface) transmitter 318, which in turn outputs a video signal in DVI format to a DTV/HDTV. Similarly HDMI (high definition multimedia interface) output is achieved from audio video decoder via a HDMI source 319.

All these analog and digital connections make CPE 300 compatible with a huge range of present and future consumer electronics products. DC power supply to CPE 300 is achieved from a dedicated power supply unit 320, which generates regulated DC output from AC mains supply.

Thus, the present invention provides a system for multimedia on demand over an internet-based network to provide on-demand audio video programs via internet to customer premises at any time. The invention in various embodiments as disclosed herein is further capable of providing other value added services through the same system.

While the invention has been particularly explained with reference to one or more preferred embodiments, it will be understood by those skilled in the art that various changes in form and detail may be made therein without departing from the spirit and scope of the invention.

What is claimed is:

1. A multimedia on demand system, comprising:
a multimedia server configured to connect to an internet-based network and to transmit audio/video programs on demand via said internet-based network;
a plurality of customer premises units connected to the internet-based network via a network interface and configured to receive said audio/video programs via said internet-based network;
a remote control unit in communication with each customer premises unit to provide user input to the unit.
an audio video system connected to each customer premises unit.

2. The multimedia on demand system of claim 1, wherein the system is configured to provide a plurality of program content selected from the set consisting of: video programs on demand, songs in compressed audio format on demand, a product catalog, a tourist guide, and video games on demand, the system utilizing a single customer premises unit integrated into an existing internet based network.

3. The multimedia on demand system of claim 1, wherein the system provides two modes of video delivery to customer end over internet, said two modes comprising instant watch mode and a wait & watch mode, respectively.

4. The multimedia on demand system of claim 3, wherein the system is configured such that if internet connectivity up to customer premises is sufficient to receive a continuous video stream, then the system provides the customer with the ability to receive video in instant watching mode such that the customer can start watching the program at a time that the video is requested.

5. The multimedia on demand system of claim 3, wherein the system is configured such that if the internet connectivity is not sufficient to receive a continuous video stream, the system operates in wait & watch mode, wherein the video stream is first downloaded substantially completely and stored in the customer premises equipment before the user can start watching the program.

6. The multimedia on demand system of claim 1, wherein the customer premises equipment is configured to allow a customer to choose a display size for displaying a video portion of said audio/video programs.

7. The multimedia on demand system of claim 1, wherein a desired audio/video program is divided into various sections and the system is configured to send each section over different IP packets, each said packet including a serial number, the packets being rearranged after receipt at the customer premises and retransmission of particular packets being requested by the customer premises equipment.

8. The multimedia on demand system of claim 1, wherein the system is configured to utilize download acceleration techniques to shorten the time taken to download any said audio/video programs and to maximize channel utilization of network connectivity.

9. The multimedia on demand system of claim 1, wherein said multimedia server is located at a service provider's premises and manages a large archive of audio video programs and other information for value added services, the system further comprising a database of said archive which allows said customer premises equipment to navigate through the archive and search for a desired program.

10. The multimedia on demand system of claim 9, further comprising a network manager program running at the multimedia server, the network manager program managing various channels to serve customer requests.

11. The multimedia on demand system of claim 10, wherein the network manager program further functions to assist the server in delivering popular or more-requested programs to multicast over said internet-based network.

12. The multimedia on demand system of claim 1, wherein the multimedia server is configured to ensure only authentic usage of the services by transmitting the audio/video programs in scrambled, compressed and encrypted format such that the programs can only be descrambled, decompressed and decrypted at authentic customer premises equipment.

13. The multimedia on demand system of claim 1, wherein each of the plurality of customer premises units comprises:
a control unit to control and monitor overall operation of the device and its interface with the network;
an Ethernet PHY interface section to connect to said internet-based network via modem;
an Ethernet media access controller to control channel allocation and error-free data packet retrieval from said network;
an LCD display unit to display a currently running program title, duration of the program, elapsed time, and download mode;
a front panel keypad to receive user input to control device operation;
an IR receiver section for receiving input from an IR remote control;
a memory to store a small archive of audio/video programs and temporarily store data during audio video processing;
a means for decoding audio/video programs from standard formats;
an audio digital signal processing unit;
a video encoder to convert received digital video into a composite digital video stream;
a digital-to-analog converter to convert digital audio/video signals to analog audio/video signals;
an audio amplifier to amplify the analog audio signal before feeding it to the audio system;
a video amplifier to amplify the analog video signal before feeding it to the video system for display;
an RF modulator to convert the analog audio/video signals to RF signals to be fed into an RF input of the audio-video system;
a DVI transmitter to convert received digital audio/video programs into DVI compatible output to feed into a digital or high-definition television;
an HDMI source to convert received digital audio/video programs into HDMI-compatible output to feed into digital or high definition television sets.

14. The multimedia on demand system of claim 13, wherein the customer premises unit receives audio/video programs and data for value-added services over said internet-based network through an ethernet physical interface via a modem.

15. The multimedia on demand system of claim 13, wherein a user interface is provided via said LCD screen, front panel keypad and remote control.

16. The multimedia on demand system of claim 13, wherein a visual interface is provided to a user via a television screen.

17. The multimedia on demand system of claim 13, wherein the customer premises unit comprises a plurality of audio visual connectors, thereby providing compatibility with a wide range of audio video systems.

18. The multimedia on demand system of claim 17, wherein said connectors include analog audio video connectors for AV input, an RF cable connect connector for RF video output to an analog television, a digital video interface connector, and a high-definition multimedia interface connector.
